(19) United States
(12) Patent Application Publication
(10) Pub. No.: US 2025/0143218 A1
(43) Pub. Date: May 8, 2025

(54) A WINDROW FORMING DEVICE

(71) Applicant: PLOEGER OXBO HOLDING B.V., Roosendaal (NL)

(72) Inventors: Hendrik Willem BREURE, Roosendaal (NL); Marinus Adriaan GROOTJANS, Roosendaal (NL)

(73) Assignee: PLOEGER OXBO HOLDING B.V., Roosendaal (NL)

(21) Appl. No.: 18/836,994

(22) PCT Filed: Mar. 16, 2023
(86) PCT No.: PCT/NL2023/050133

§ 371 Date: Aug. 8, 2024

(30) Foreign Application Priority Data
Mar. 21, 2022 (NL) 2031340

(51) Int. Cl. A01D 84/00; A01D 57/20; A01D 89/00

(52) U.S. Cl. CPC A01D 84/00; A01D 57/20; A01D 89/001

(57) ABSTRACT

A windrow forming device is movable over ground in a direction of travel. The windrow forming device is provided with a rigid frame, at least one pick-up mechanism for picking up a product from the ground, and at least one conveyor belt arranged to convey the picked up material in at least one direction extending sidewards with respect to the direction of travel, and to deposit the material on the ground for forming a windrow. The windrow forming device may be a self-propelled agricultural machine, for example a self-propelled merger, or a pulled agricultural machine having at least one windrow forming device.

The invention relates to a windrow forming device, which is movable over ground in a direction of travel, wherein the device is provided with a rigid frame, at least one pick-up mechanism for picking up a product from the ground, and at least one conveyor belt arranged to convey the picked up material in at least one direction extending sidewards with respect to the direction of travel, and to deposit said material on the ground for forming a windrow.

The invention also relates to a self-propelled agricultural machine, for example a self-propelled merger, or a pulled agricultural machine comprising at least one windrow forming device as specified in this disclosure.

WO2022045883 discloses a windrow forming device and a self-propelled agricultural machine, in particular a merger, or a pulled agricultural machine comprising at least one windrow forming device.

Although the known windrow forming device gives excellent results for forming windrows on the land at relatively high speeds of travel, one object of the present invention is further improvement of the windrow forming device, in particular an improved pick-up of product from the ground.

This object is achieved with the windrow forming device as is defined in claim 1.

The windrow forming device is movable over ground in a direction of travel. The windrow forming device is provided with a rigid frame, a first and a second pick-up mechanism for picking up a product from the ground, and at least one transport mechanism, for example a conveyor belt, arranged to convey the picked up material in at least one direction extending sidewards with respect to the direction of travel, and to deposit said material on the ground for forming a windrow. The first pick-up mechanism is connected in a rigid manner to the rigid frame and the second pick-up mechanism is pivotably mounted to the first pick-up mechanism.

The windrow forming device provided with at least two pick-up mechanisms, instead of one as disclosed in WO2022045883, provides a relatively large working unit width of the device and improves pick-up of product from the ground by means of the two pick-up mechanisms, because one of the two pick-up mechanisms is able to pivot with respect to the other pick-up mechanism. The working unit width of the device extends in a direction substantially traverse to the direction of travel. It is even possible by means of the two pick-up mechanisms to provide a device with a larger working width than the working width of the single pick-up mechanism as disclosed in WO2022045883. The pivotable connection between the second pick-up mechanism and the first pick-up mechanism, provides a flexible connection such that the first and second pick-up mechanisms are able to move with respect to each other. This flexible connection provides improved ground following capability of the pick-up mechanisms, in particular for uneven grounds, and decreases the risk or decreases the impact that components, for example tines, of the pick-up mechanism contact obstacles and/or the ground which may cause damage to the pick-up mechanism. In addition, the flexible connection makes it possible to improve pick-up of product from the ground and/or to reduce the pick-up of soil, in particular on an uneven ground.

As a result of the rigid frame to which one of the two pick-up mechanisms is connected in a rigid manner, a relatively simple, mechanically strong and reliable device can be provided from a constructional point of view and/or with a long lifespan. The second pick-up mechanism may be pivotably mounted to the rigid frame, which may further improves the aforementioned constructional beneficial properties. The term “rigid” in this disclosure means that the respective component should be considered to be stationary with respect to other components of the device, even when the complete windrow device, including for example the rigid frame, can be moved by (or in) an agricultural machine.

The pick-up mechanisms are elongate pick-up mechanisms with a length, wherein the length is the largest dimension of the pick-up mechanism. In an operative device, the length of the adjacently arranged pick-up mechanisms extends in a direction substantially traverse to the direction of travel, i.e. the total length of the pick-up mechanisms defines largely, if not substantially or completely, the working width of the windrow forming device. Each pick-up mechanism comprises a pick-up rotor with a rotation axis, wherein if the pick-up mechanisms are in a working position the rotation axes of the pick-up rotors of the pick-up mechanisms can or will be aligned, i.e. on flat ground without obstacles the rotations axes of the pick-up rotors of the pick-up mechanisms are aligned.

In one aspect of the windrow forming device, the device is provided with at least one third pick-up mechanism. In a first arrangement of a device with at least three pick-up mechanisms, the first pick-up mechanism is provided between the second pick-up mechanism and the third pick-up mechanism, wherein the third pick-up mechanism is pivotably mounted to the first pick-up mechanism. This first arrangement is a relatively flexible arrangement with a relatively large working width which is able to provide excellent ground following properties, increased obstacle impact reduction and improved product pickup results as a result of the pivotably mounted outer pick-up mechanisms with respect to the first pick-up mechanism. The third pick-up mechanism may be pivotably mounted to the rigid frame.

In an alternative second arrangement of a device with at least three pick-up mechanisms, the second pick-up mechanism is provided between the first pick-up mechanism and the third pick-up mechanism, wherein the second pick-up mechanism is pivotably mounted to the third pick-up mechanism. The third pick-up mechanism may be connected in a rigid manner to the rigid frame. The second arrangement of the device may also provide improved flexibility regarding ground following, obstacle impact reduction and improved product pick-up.

In one aspect, the device comprises at least three ground following members mounted on the pick-up mechanisms, preferably four ground following members, wherein at least one ground following member is connected in a rigid manner to the rigid frame, preferably at least two ground following members are connected in a rigid manner to the rigid frame. Depending on certain conditions for the desired arrangement, for example selected on ground contour conditions, more or less rigidly connected ground following members may be selected, wherein the other ground following member(s) is (are) pivotably connected to the rigid frame. In this manner, it is possible to obtain a windrow forming device with improved ground contour following performance. The device provides a variable design with respect to the ground following members carrying the device. The ground following members allow for each pick-up mechanism an accurately defined distance to be maintained from the ground, such that dirt ingress and performance losses as a result of the pick-up tools engaging the ground/soil can be reduced and the amount and/or quality of the product pick-up can be increased.

In a further aspect, one of the pick-up mechanisms is driven to mutually drive the other pick-up mechanism(s) of the device in rotation. Such a configuration with a single drive for all the pick-up mechanisms of the device provides a relatively simple device from a constructional point of view. In such a construction of the device at least one coupling between shafts of the pick-up mechanisms, for example an elastic coupling or a cardan coupling, is used for connecting the driven shaft of one pick-up mechanism with the other shafts of the other pick-up mechanism(s).

A rigid connection between at least one of the pick-up mechanisms and the rigid frame may be provided by a rigid carrier, normally an elongate rigid carrier. One of the rigid carriers may be supported by a ground following member. This ground following member may be connected in a rigid manner to the pick-up mechanism. The other end of the rigid carrier may be connected in a rigid manner to the rigid frame. By means of this rigid connection, i.e. a non-pivotable connection, a relatively inflexible pick-up mechanism in the device can be provided which may provide a stable basis for the pivotably mounted pick-up mechanism(s). With such a construction of the pick-up mechanisms an improved pick-up can be obtained. A pivotable connection between at least one of the pick-up mechanisms and the rigid frame may be provided by a hingeable carrier, normally an elongate hingeable carrier. One end of the hingeable carrier may be supported by a ground following member. This ground following member may be connected in a rigid manner to the pick-up mechanism. The other end of the hingeable carrier may be connected by a hinge mechanism to the rigid frame. By means of the hingeable carrier a relatively flexible, but mechanically strong device can be provided with improved ground following performance, increased obstacle impact reduction and improved pick-up performance.

It is also an object to provide an improved agricultural machine. This object is achieved with the agricultural machine as claimed. The agricultural machine may be a self-propelled agricultural machine or a pulled agricultural machine, wherein the agricultural machine comprises at least one windrow forming device of this disclosure, preferably at least two of these windrow forming devices. In the agricultural machine, the at least one windrow forming device may be moveable from a transport position to a working position, and vice versa, wherein in the working position a maximum width of the machine seen in a direction traverse to the direction of travel is larger by means of the at least one device than in the transport position, preferably at least 1.5 times larger.

Finally, the invention also relates to the use of an agricultural machine or the windrow forming device of this disclosure. In order to avoid unnecessary repetitions, the reader is referred to the advantages of the use of the windrow forming device which have already been described in this document regarding the agricultural machine comprising the windrow forming device and/or the windrow forming device.

The above-described aspects will be explained below by means of exemplary embodiments in combination with the figures. However, the invention is not limited to the exemplary embodiments described below. Rather, a number of variants and modifications are possible which also use the inventive idea and therefore fall within the scope of protection. In particular, the possibility of combining the features/aspects which have only been mentioned in the description and/or been shown in the figures with the features of the claims, in so far as they are compatible, is mentioned.

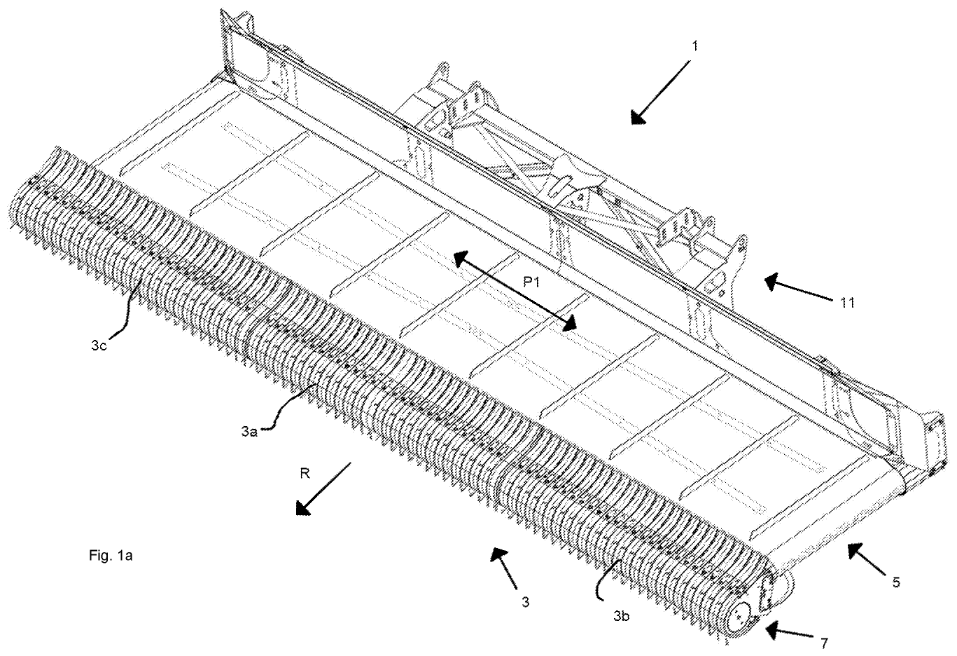

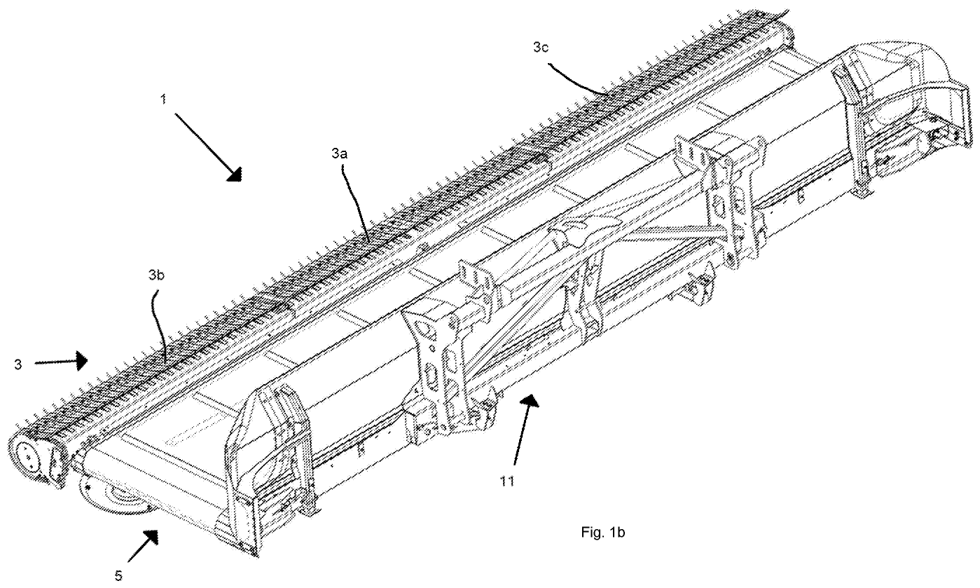

FIGS. 1a, 1b show perspective views of a windrow forming device;

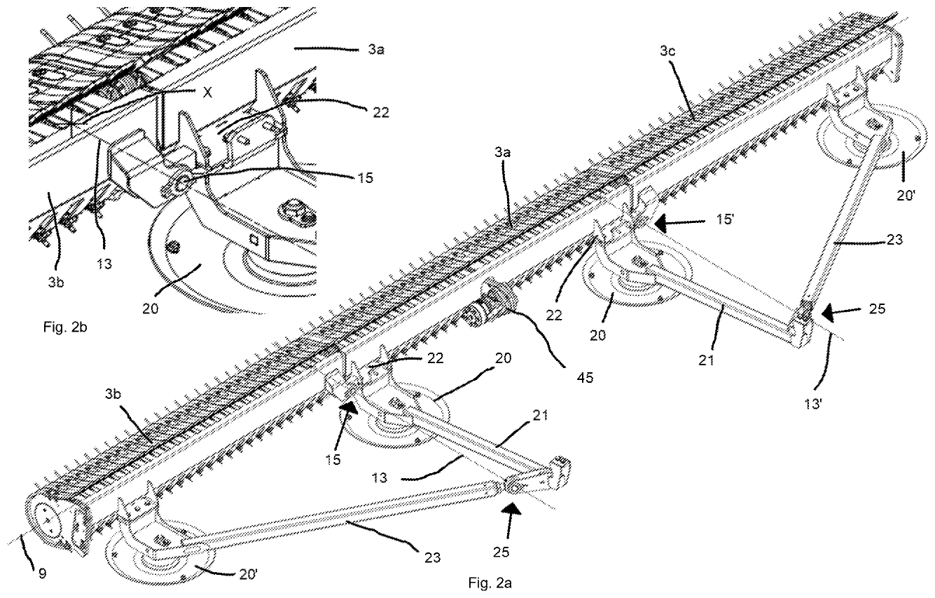

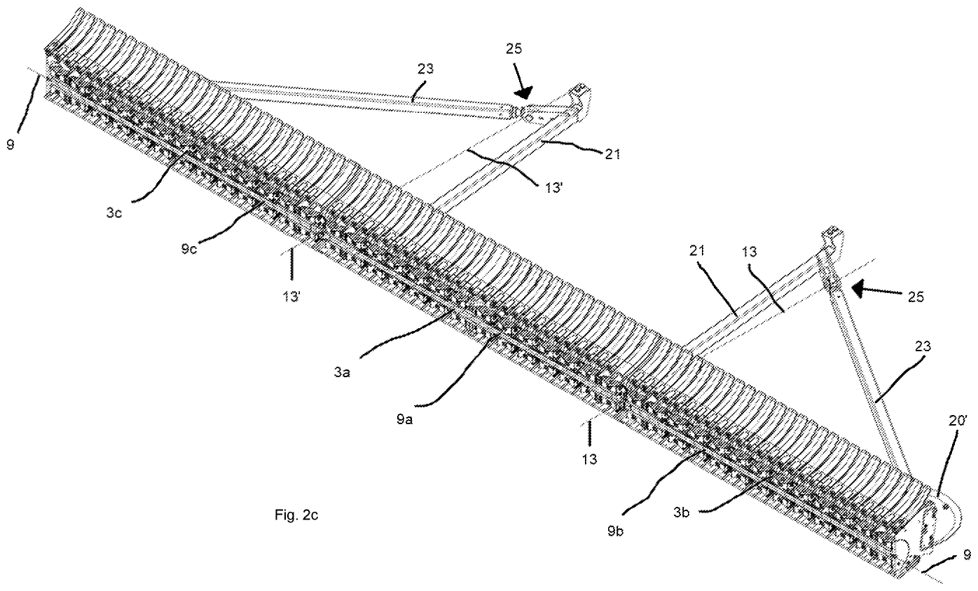

FIGS. 2a-c show perspective views of components of the windrow forming device shown in FIGS. 1a, 1b;

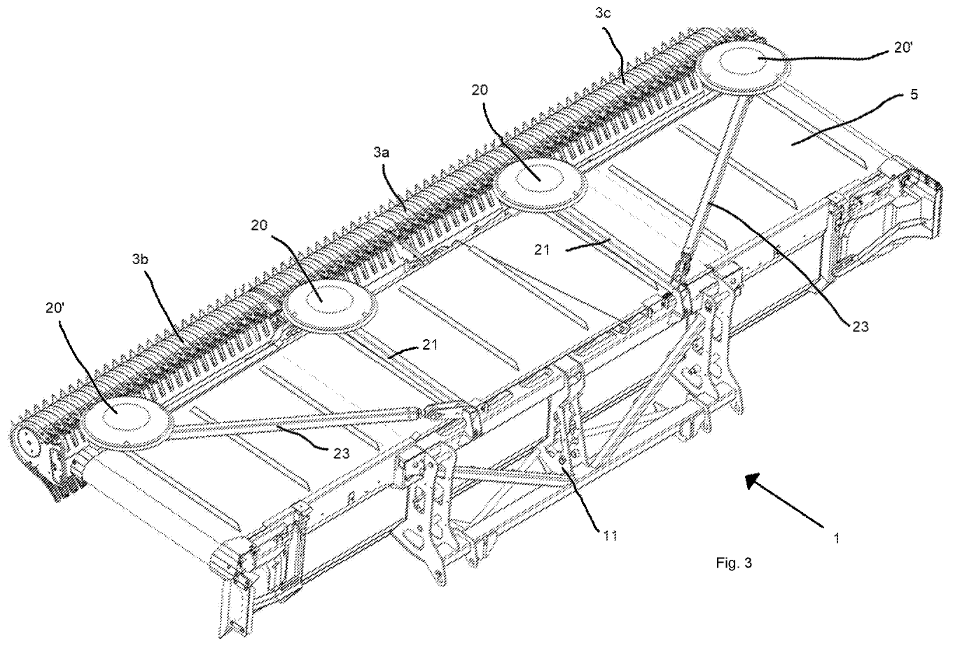

FIG. 3 shows a perspective view of the windrow forming device shown in FIGS. 1a, 1b from below;

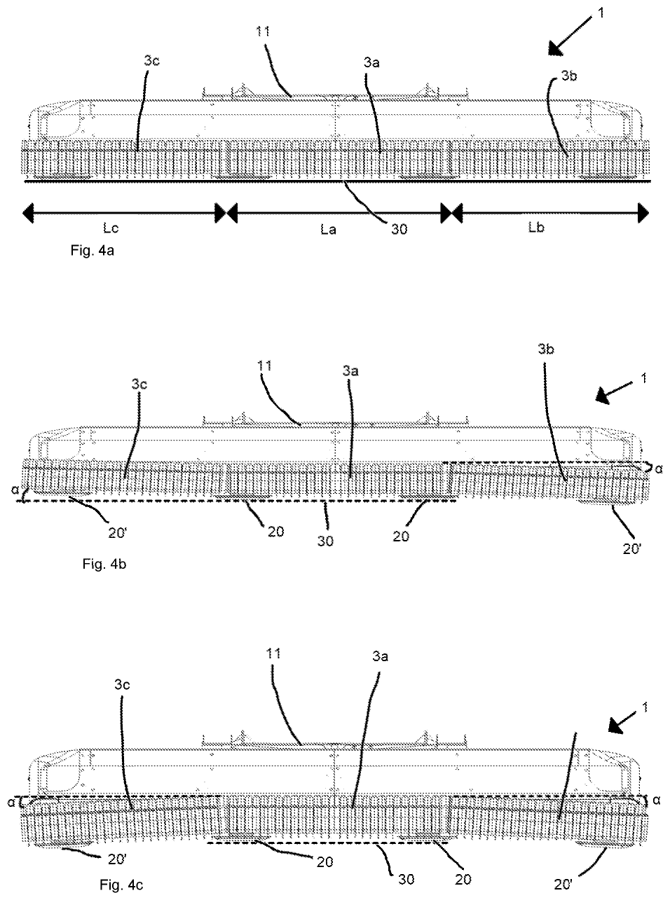

FIGS. 4a-4c show front views of the windrow forming device;

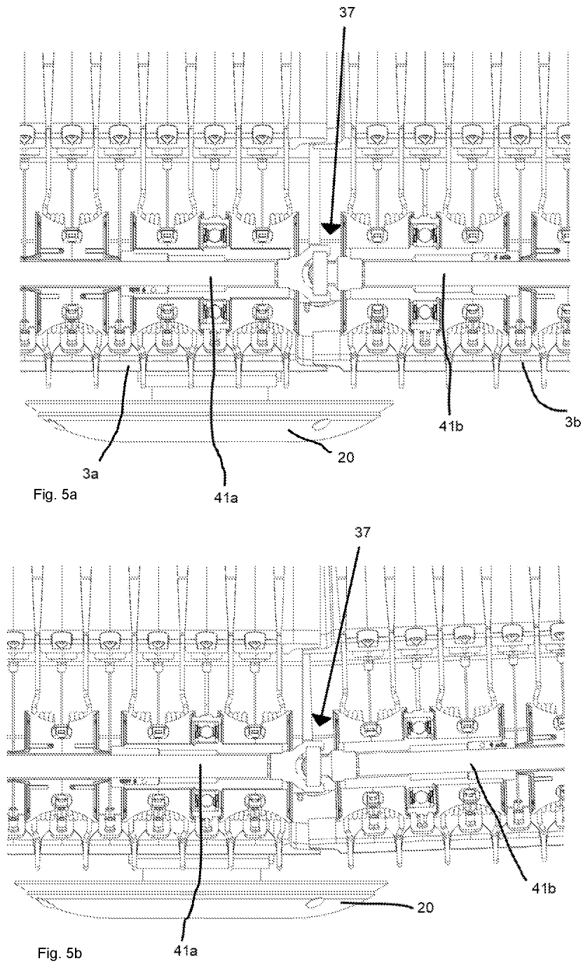

FIGS. 5a, 5b show details of the windrow forming device.

In the figures, similar components/features are denoted with the same reference signs.

The windrow forming device 1 shown in the figures may be incorporated both in a self-propelled agricultural machine and in a pulled agricultural machine.

In the case of application of the device in a merger such as is known from WO2020/046114 A1, the merger comprises at least two windrow forming devices 1, so that besides deposition to the left or right of the merger, central deposition is also possible. For details of a merger, reference is made to WO2020/046114 A1. Besides application of the device 1 in a self-propelled agricultural machine, such as said merger, the device 1 may also be employed in a pulled agricultural machine (not shown).

By means of the windrow forming device 1 shown in the figures, in operation, an agricultural working (processing) of the land is to be carried out. More particularly, each device 1 of elongated configuration shown is provided with a product pick-up mechanism unit 3 for picking up a plant material product from the land, for example for picking up hay or a similar product, as well as a transport mechanism, i.e. a conveyor belt 5, wherein by means of the conveyor belt 5, product picked up by means of the pick-up mechanism unit 3 is to be conveyed (transported) in one of the directions represented by arrow P1, i.e. sideways relative to the direction of travel R of the agricultural machine (not shown) and the device 1 in a direction of transport (P1) and is to be deposited on the land. The elongate conveyor belt 5 extends mainly in a direction traverse to the direction of travel and is positioned between the pick-up mechanism unit 3 and a rigid frame 11 of the device 1. The elongate conveyor belt 5 may be connected in a rigid manner to the rigid frame 11.

The pick-up mechanism unit 3 comprises at least one pick-up rotor 7, which is configured to pick up product from the land by means of a rotating motion about a rotation axis 9 (FIGS. 2a, 2c) extending substantially parallel to the direction of transport P1 of the conveyor belt 5. The conveyor belt 5 of the device will deposit product in an efficient and uniform manner back on the land to the left or right relative to a direction of travel R for forming a windrow. Using the conveyor belt 5 assures excellent transport of the product for forming windrows independent of the conditions, such as the condition of the product or weather conditions, in particular when windrows are being formed with high speeds in the direction of travel R, such as in the above mentioned merger.

The windrow forming device 1 may also comprise multiple conveyor belt sections (not shown) forming the conveyor belt 5, such that for example a first conveyor belt section is able to transport product in a first direction indicated with arrow P1, wherein a second conveyor belt section is able to transport product in a direction opposite to the first direction.

The windrow forming device 1 as shown in the figures comprises a pick-up mechanism unit 3 having a first pick-up mechanism 3a which is connected in a rigid manner to a rigid frame 11 of the windrow forming device 1 and a second pick-up mechanism 3b which is pivotably mounted to the first pick-up mechanism 3a. As can be seen in FIGS. 2a, 2b, a rotation axis 13 of the rotary (pivot) connection 15 between the first pick-up mechanism 3a and the second pick-up mechanism 3b provides the movability between the first pick-up mechanism 3a and the second pick-up mechanism 3b. In other words, the second pick-up mechanism 3b is able to pivot around rotation axis 13 with respect to the first pick-up mechanism 3a. This rotary (pivot) connection 15 between at least two pick-up mechanisms provides the advantages as mentioned above with respect to ground following performance, obstacle impact reduction and/or improved picking up product from the ground.

In the embodiment shown in the figures the windrow forming device 1 comprises a third pick-up mechanism 3c which will be further discussed below. The pick-up mechanisms 3a-c are elongate pick-up mechanisms with a length La, Lb, Lc (see FIG. 4a), wherein the length is the largest dimension of the pick-up mechanism 3a-c. In an operative device 1, the length of the adjacently arranged pick-up mechanisms 3a-c extends in a direction substantially traverse to the direction of travel R. The total length of the pick-up mechanisms 3a-c defines the working width (La+Lb+Lc) of the windrow forming device 1. The lengths La, Lb, Lc of the pick-up mechanism 3a-c may be substantially identical as shown in the figures.

The conveyor belt 5 may be directly connected to the first pick-up mechanism 3a or indirectly connected thereto by means of the rigid frame 11. The conveyor belt is not directly connected to the second pick-up mechanism 3b and the third pick-up mechanism 3c, i.e. the second and third pick-up mechanism 3b, 3c are connected in an indirect manner to the conveyor belt 5 by means of the rigid frame 11.

Each pick-up mechanism 3a-c comprises a pick-up rotor 7 as mentioned above, each providing a portion 9a, 9b, 9c (FIG. 2c) of the rotation axis 9 of the device 1, wherein if the pick-up mechanisms 3a-c are in a working position the rotation axis portions 9a-c of the pick-up rotors 7 of the pick-up mechanisms 3a-c can or will be aligned, i.e. on a flat ground 30 as shown in FIG. 4a the rotations axis portions 9a-c of the pick-up rotors 7 of the pick-up mechanisms 3a-c are aligned, see also dotted line 9 in FIGS. 2a, 2c representing the three rotations axis portions 9a-c.

In the device 1 as shown with three pick-up mechanisms 3a-c, the first pick-up mechanism 3a is provided between the second pick-up mechanism 3b and the third pick-up mechanism 3c, wherein the third pick-up mechanism 3c is pivotably mounted to the first pick-up mechanism 3a. FIG. 2a shows a rotation axis 13′ of the rotary (or pivot) connection 15′ between the first pick-up mechanism 3a and the third pick-up mechanism 3c. In the embodiment shown in the figures, the second 3b and third 3c pick-up mechanism are pivotably mounted to the rigid frame 11. In the device (not shown), it is also possible that the second 3b and third 3c pick-up mechanism are only pivotably mounted to the first pick-up mechanism 3a, i.e. without being mounted to the rigid frame 11, at least not in a direct manner. The arrangement of the pivotably mounted outer pick-up mechanisms 3b, 3c with respect to the first pick-up mechanism 3a provides a flexible device 1 with a relatively large working width.

The windrow forming device 1 further comprises ground following members 20, 20′ mounted on or to the pick-up mechanisms 3a-c by means of a rigid (non-pivotable) connection. The ground following members 20, 20′ support (carry) the windrow forming device 1. The shown four ground following members 20, 20′ comprise ground following member 20 which are connected in a rigid manner to the rigid frame 11, and ground following members 20′ which are pivotably connected to the rigid frame 11.

A rigid connection between the first pick-up mechanism 3a and the rigid frame 11 is provided by two elongate carriers 21, wherein one end of each carrier 21 is supported by a ground following member 20 which is connected in a rigid manner to the pick-up mechanism 3a and the other end of each carrier 21 is connected in a rigid manner to the rigid frame 11. By means of this rigid connection a relatively inflexible pick-up mechanism 3a is provided which provides a stable basis for the pivotably mounted pick-up mechanisms 3b, 3c. The rotary (or pivot) connection 15, 15′ of the second and third pick-up mechanism 3b, 3c is in the embodiment shown connected to the first pick-up mechanism 3a by the same connection 22 which connects the ground following member 20 to the first pick-up mechanism 3a. Alternative connection arrangements, such as a separate connection (not shown) between the rotary (or pivot) connection 15, 15′ and the first pick-up mechanism 3a, are also possible. A pivotable connection between the second and third pick-up mechanisms 3b, 3c and the rigid frame 11 is provided by a hingeable elongate carrier 23, wherein one end of each carrier 23 is supported by a ground following member 20′ which is connected in a rigid manner to the respective pick-up mechanism 3b, 3c and the other end of each carrier 23 is connected by a hinge mechanism 25 to the rigid frame 11. The pivot axis 13, 13′ for pivotably mounting the pick-up mechanisms 3a-c to each other extends substantially in the direction of travel R. It is possible that the pivot axis 13, 13′ forms an angle between 0° and approximately 45° with the direction of travel. The carriers 21 also extend substantially in the direction of travel R, but the ends of the carriers 21 are located at various heights seen in the vertical direction, wherein this height difference causes the different orientations of these carriers 21 with respect to the pivot axes 13, 13′ in FIGS. 2a-c. The angle between carrier 21 and carrier 23 lies, seen from above, between 30-60 degrees.

The pivotable connections 15, 15′ between the pick-up mechanisms 3a-c provide flexible connections such that the pick-up mechanisms are able to move with respect to each other. This movement of the pick-up mechanism with respect to each other is shown in FIGS. 4a-c. In FIG. 4a, a flat ground surface is indicated with solid line 30. In FIGS. 4b and 4c the flat ground surface is indicated with dotted lines, because the movements of the pick-up mechanisms 3a-c shown in FIGS. 4b and 4c may be the result of an uneven ground contour (not shown), but also other external factors/forces may result in the shown positions such as for example obstacles. The depicted positions of the pick-up mechanisms 3a-c in FIGS. 4b, 4c, shown by angles α, demonstrate a stable central first pick-up mechanism 3a and flexible outer pick-up mechanisms 3b, 3c that are able to pivot with respect to the first pick-up mechanism. Without wishing to be bound by theory, it is believed that for a smooth operation of the device 1, it is beneficial that the pivot axis 13, 13′ intersects with the rotation axis 9 (9a-c) of the pick-up mechanisms 3a-c. As shown in FIGS. 2a, 2b by means of cross X, the angle of intersection between the pivot axis 13, 13′ with the rotation axis 9 is a substantially perpendicular angle. Further, it has been proven beneficial from a constructional point of view when the at least one pivot axis 13, 13′ between the pick-up mechanisms 3a-c intersects the center of the at least one hinge mechanism 25 (see FIGS. 2a, 2c). The center of hinge mechanism 25 may form a rotation center, for example of a ball joint, or the center of the rotation axis for example of a pivot pin.

As is also shown in FIG. 2a, the pick-up rotor of the first pick-up mechanism 3a can be driven solely by means of a drive unit 45 to mutually drive the pick-up rotors of the other pick-up mechanism(s) 3b, 3c of the device 1 in rotation around rotation axis 9. By means of a coupling 37 (see FIGS. 5a, 5b) between shafts 41a, 41b of the pick-up mechanisms 3a, 3b, for example an elastic coupling or a cardan coupling, the shafts 41a, 41b can be coupled in a moveable manner with respect to each other, wherein the single drive unit 45 is able to drive the pick-up rotor of each pick-up mechanism 3a-c. Such a configuration with a single drive for all the pick-up mechanisms 3a-c and/or the coupling 38 provide a relatively simple, mechanically strong and reliable device 1. As a result of the flexible coupling 37, it is demonstrated in FIG. 5b that the shafts 41a, 41b can be moved in a mechanical stable manner from an aligned position with respect to each other as shown in FIG. 5a to an articulated, non-aligned, position with respect to each other as shown in FIG. 5b as a result of the pick-up mechanisms 3a-c pivoting around the pivotable connections 15, 15′.

In an alternative not shown arrangement of the device with at least three pick-up mechanisms, the second pick-up mechanism may be provided between the first pick-up mechanism and the third pick-up mechanism, wherein the second pick-up mechanism is pivotably mounted to the first pick-up mechanism and pivotably mounted to the third pick-up mechanism. The first pick-up mechanism may be connected in a rigid manner to the rigid frame, wherein the second pick-up mechanism may be pivotably mounted to the rigid frame. The third pick-up mechanism may also be connected in a rigid manner to the rigid frame.

Further, it is possible that a windrow forming device (not shown) comprises more than three pick-up mechanisms.

1. A windrow forming device, which is movable over ground in a direction of travel, the device comprising a rigid frame, a first and a second pick-up mechanism for picking up a product from the ground, and at least one transport mechanism, comprising a conveyor belt, arranged to convey the picked up material in at least one direction extending sidewards with respect to the direction of travel, and to deposit said material on the ground for forming a windrow, wherein the first pick-up mechanism is rigidly connected to the rigid frame and the second pick-up mechanism is pivotably mounted to the first pick-up mechanism.

2. The device of claim 1, wherein the second pick-up mechanism is pivotably mounted to the rigid frame.

3. The device of claim 1, wherein the device comprises a third pick-up mechanism, wherein the first pick-up mechanism is between the second pick-up mechanism and the third pick-up mechanism, wherein the third pick-up mechanism is pivotably mounted to the first pick-up mechanism, the third pick-up mechanism is pivotably mounted to the rigid frame.

4. The device of claim 2, wherein the device comprises a third pick-up mechanism, wherein the second pick-up mechanism is between the first pick-up mechanism and the third pick-up mechanism, wherein the second pick-up mechanism is pivotably mounted to the third pick-up mechanism, the third pick-up mechanism is rigidly connected to the rigid frame.

5. The device according to claim 1, wherein the device comprises at least three ground following members mounted on the pick-up mechanisms, wherein at least one ground following member is connected in a rigid manner to the rigid frame, at least two ground following members are connected in a rigid manner to the rigid frame.

6. The device according to claim 1, wherein a pivot axis for pivotably mounting the pick-up mechanisms to each other extends essentially in the direction of travel, wherein the pivot axis forms an angle between 0° and approximately 45° with the direction of travel.

7. The device according to claim 6, wherein the pivot axis or axes intersect(s) with a rotation axis of the pick-up mechanisms, at a substantially perpendicular angle.

8. The device according to claim 1, wherein one of the pick-up mechanisms is drivable to mutually drive the other pick-up mechanism(s) of the device in rotation and/or the pick-up mechanisms comprise at least one coupling between rotary shafts of the pick-up mechanisms, comprising an elastic coupling or a cardan coupling.

9. The device according to claim 1, wherein the at least one transport mechanism extends between the pick-up mechanisms and the rigid frame.

10. The device according to claim 1, wherein a rigid connection between at least one of the pick-up mechanisms and the rigid frame is comprises a rigid carrier, one end of the rigid carrier is supported by a ground following member which is rigidly connected to the pick-up mechanism and the other end of the rigid carrier is rigidly connected to the rigid frame.

11. The device according to claim 1, wherein a pivotable connection between at least one of the pick-up mechanisms and the rigid frame comprises a hingeable carrier, one end of the hingeable carrier is supported by a ground following member rigidly connected to the pick-up mechanism and the other end of the hingeable carrier is connected by a hinge mechanism to the rigid frame.

12. The device according to claim 6, wherein the at least one pivot axis intersects a center of the at least one hinge mechanism.

13. A self-propelled merger, said self-propelled merger comprising at least one windrow forming device according to claim 1.

14. A pulled agricultural machine comprising at least one windrow forming device according to claim 1.

15. The agricultural machine according to claim 13, wherein the at least one windrow forming device is moveable from a transport position to a working position, and vice versa, wherein in the working position a maximum width of the machine in a direction traverse to the direction of travel is at least 1.5 times larger than a width of the at least one device in the transport position.

16. (canceled)
